(19) United States
(12) Patent Application Publication
(10) Pub. No.: US 2005/0206803 A1
(43) Pub. Date: Sep. 22, 2005

(54) LIQUID CRYSTAL DISPLAY DEVICE

(75) Inventor: Noriyuki Suzuki, Mori-machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori-machi (JP)

(21) Appl. No.: 10/906,844

(22) Filed: Mar. 9, 2005

(30) Foreign Application Priority Data
Mar. 19, 2004 (JP) 2004-079556

(51) Int. Cl. G02F 1/1335

(52) U.S. Cl. 349/61

(57) ABSTRACT

A liquid crystal display device for a variety of applications in which the luminous intensity of the display can be adjusted either at the operators desire or automatically to provide the desired relation between the contrast of the display and the backlight.

### BACKGROUND OF THE INVENTION

This invention relates to a liquid crystal display device and more particularly to a liquid crystal display that automatically adjusts the display in response to changes in ambient light conditions to improve its readability under varying ambient conditions.

Conventionally, it has been proposed to use a liquid crystal as an image display to display information in a compartment of various types of passenger vehicles. By way of example, they may be used to display for example the outputs of various measurement instruments of the vehicle or its surrounding. Also, recently, some of image display sections of personal computers or television sets have the liquid crystal, and the liquid crystal is expected to be used in an increasing number of fields in the future.

Because a liquid crystal panel of the liquid crystal display device has a structure that does not emit light by itself, normally a luminous body called as “backlight” is disposed in the rear of the panel. Although a fluorescent tube can be used as the backlight, its display surface becomes darkened with time because the luminous intensity decreases as the operating time elapses. Thus the contrast decreases with an attendant deterioration in image quality and the display becomes indistinct.

Therefore, a device for varying a drive voltage of the backlight in accordance with the operating time to adjust the contrast of the liquid crystal has been suggested see for example Japanese Published Application Hei 6-167695. This arrangement provides a contrast adjusting device that supplies a increased voltage to the liquid crystal panel according to the elapsed operating time to compensate the fall of the luminous intensity. This is to compensate for the reduction of the contrast.

In addition to the time deterioration of the contrast, these types of devices are frequently used in an environment where the surrounding light conditions may vary considerably. For example, the liquid crystal display device installed in a boat the surrounding light amount can vary considerably. By way of example, at night the operator's sight can not adjust rapidly enough to recover when the operator turns his or her eyes toward other instruments or surroundings so that they will be instantly visible.

In such an arrangement the conventional liquid crystal display device, because a device drive voltage that gives the contrast is fixed, the fall of the luminous intensity of the backlight itself is inevitably accompanied with the fall of the contrast so that the image is likely to be indistinct until the operator's eyes can adjust. The aforedescribed prior art does not meet the necessity of the contrast adjustment suitable for those required by changes in surrounding operating environments.

Therefore it is a principal object of this invention to provide a liquid crystal display that compensates for varying conditions of operation.

### SUMMARY OF THE INVENTION

This invention is adapted to be embodied in a liquid crystal display

### BRIEF DESCRIPTION OF THE DRAWINGS

FIG. 1 is a partially schematic view of a liquid crystal display in accordance with a first embodiment of the invention.

FIG. 2 is a partially schematic view of a liquid crystal display in accordance with a second embodiment of the invention.

### DETAILED DESCRIPTION

Referring now in detail to the drawings and initially to the embodiment of FIG., a liquid crystal display device, indicated generally by the reference numeral 11 includes a liquid crystal display (LCD) 12 and an EL (electronic luminescence) backlight 13. The liquid crystal display 12 is driven by a control unit (CPU) 14 that inputs a display signal (not shown). This control unit 14 forms an LCD drive circuit. An LCD drive signal is outputted to the liquid crystal display 12 from a LCD drive output port 14a.

The backlight 13 is furnished on a rear face of the liquid crystal display 12. Also, a power source circuit, indicated generally at 15, drives this backlight 13. The power source circuit 15 includes an inverter circuit 16 for the EL that outputs an AC drive voltage for the EL to the backlight 13. Further, the same power source circuit 15 includes multiple (four in the present embodiment) Zener diodes 17a, 17b, 17c and 17d those which are connected to the inverter circuit 16 through a transistor 18. The Zener diodes 17a-17d are used to obtain a fixed voltage to drive the backlight, and the respective Zener diodes 17a-17d are connected in series. Additionally, a resistor 19 is interposed between a cathode (upper side in the figure) of the Zener diode 17a that is positioned most closely to the transistor 18 and the collector of the transistor 18.

Coupling portions existing between the respective Zener diodes 17a-17d are connected to control output ports 14b of the control unit 14. Each of control output ports 4b has a respective switch S1, S2 and S3 that is formed by a transistor. Each end of the switch is grounded (only the one for the switch S1 is shown). These switches S1, S2 and S3 are set to be turned on or off by the operator so as to adjust the luminous intensity of the backlight 13 in accordance with the operating conditions and environments.

For instance, under a condition that all the switches S1, S2 and S3 are off, a grounded portion of this backlight power source circuit 15 is an anode (lower side in the figure) of the Zener diode 17d. A back panel reference voltage V_{EL} thus corresponds to the voltage of four Zener diodes, which is the highest voltage. The EL backlight 13 emits light with the highest luminous intensity (brightness), under this condition.

Under another condition that only the switch S1 is turned on, the grounded portion of this backlight power source circuit 15 is an anode of the Zener diode 17c, and the back panel reference voltage corresponds to the voltage of three Zener diodes. The EL backlight 13 thus emits light with the second highest luminous intensity.

Under a further condition that only the switch S2 is turned on, the grounded portion of the backlight power source circuit 15 is an anode of the Zener diode 17b, and the back panel reference voltage V_{EL} corresponds to the voltage of two Zener diodes.

Under a further condition that only the switch S3 is turned on, the grounded portion of the backlight power source circuit 15 is an anode of the Zener diode 17a, and the back panel reference voltage V_{EL} corresponds to the voltage of one Zener diode. The EL backlight 13 thus emits light with the lowest luminous intensity.

As thus described, the liquid crystal display device of the embodiment supplies the drive voltage that is variable stepwise to the EL backlight 13 in accordance with the switch selection so that the luminous intensity is adjustable by the operator. Additionally, the adjustment of the luminous intensity is not limited to that made by the operator. For example, a sensor (not shown) that detects the surrounding light amount can be provided to automatically adjust the luminous intensity in accordance with the detected surrounding light amount.

According to this embodiment, a liquid crystal display power source circuit 21 is provided to supply different voltages to the liquid crystal display 12 along with the operations of the backlight power source circuit 15 described above (specifically, the on or off operations of the switches S1, S2 and S3). The liquid crystal display power source circuit 21 that drives this liquid crystal display 12 includes multiple (four in the present embodiment) Zener diodes 22a, 22b, 22c and 22d similarly to the backlight power source circuit 15 described above. The Zener diodes 22a-22d are used to obtain a desired voltage to drive the display, and are connected in series like those of the drive circuit 15. Additionally, a resistor 23 is connected to a cathode (upper side in the figure) of the Zener diode 22a. A voltage at a position between the Zener diode 22a and the resistor 23 is inputted to the control unit 14 as a liquid crystal display drive voltage V_{LCD}.

Coupling portions existing between the respective Zener diodes 22a-22d are connected to control output ports 14b of the control unit 14. Each control output port 14b has a switch (transistor) S4, S5 and S6, and each end thereof is grounded. These switches are set to be turned on or off by the control unit 14 itself in accordance with the on-off conditions of the switches S1, S2 and S3 associated with the backlight reference voltage control. The drive voltage of the liquid crystal display 12 is therefore varied so that the so-called contrast is automatically adjusted.

Table 1 shows an exemplary change operation of the switches S1, S2, S3, S4, S5 and S6.

TABLE 1

| | Liquid crystal | | |
|---|---|---|---|
| Backlight drive | drive circuit | Luminous | |
| circuit switches | switches | intensity | Contrast |
| all the S1, S2, | only S4 on | V_{EL} high | V_{LCD} low |
| S3 off | | (bright) | (weak) |
| only S1 on | only S5 on | ↑ | ↓ |
| only S2 on | only S6 on | ↑ | ↓ |
| only S3 on | all the S4, | V_{EL} low | V_{LCD} high |
| | S5, S6 off | (dark) | (strong) |

As shown in Table 1, under the condition that all the switches S1, S2 and S3 are turned off, only the switch S4 of the Zener diode 22a is turned on (grounded). As a result, the liquid crystal display drive voltage V_{LCD} corresponds to the voltage of one Zener diode, and is the lowest voltage. The liquid crystal display 12 thus outputs an image with the weakest contrast.

Similarly, under the condition that only the switches S1 is turned on, only the switch S5 connected to the anode of the Zener diode 22b is turned on (grounded). As a result, the liquid crystal display drive voltage V_{LCD} corresponds to the voltage of two Zener diodes. Thus, the liquid crystal display 12 outputs an image with the contrast slightly stronger than the contrast given when only the switch S4 is turned on.

Under the condition that only the switches S2 is turned on, only the switch S6 connected to the anode of the Zener diode 22c is turned on (grounded). As a result, the liquid crystal display drive voltage V_{LCD} corresponds to the voltage of three Zener diodes. The liquid crystal display 12 thus outputs an image with the contrast further stronger than the contrast given when only the switch S5 is turned on.

Also, under the condition that only the switches S3 is turned on, all the switches S4, S5 and S6 on the side of the liquid crystal display power source circuit 21 are turned off. As a result, the liquid crystal display drive voltage V_{LCD} corresponds to the voltage of four Zener diodes. Thus, the liquid crystal display 12 outputs an image with the contrast that is the strongest in this liquid crystal display device.

As described, according to the embodiment, when the luminous intensity of the backlight 13 is the largest (brightest), the contrast of the display 12 side is most weakened, and conversely when the luminous intensity of the backlight 13 is the smallest (darkest), the contrast of the display 12 side is most strengthened so that the actual contrast is fixed as the result. Accordingly, the display visibility is assured under every operating environment. The contrast is kept high under even an operating condition such as represented by, for example, a cockpit of a boat and such as that the luminous intensity of the backlight is lowered, and the visibility of the so-called liquid crystal display device itself is assured. Also, because, in the device of the embodiment, the backlight drive voltage and the liquid crystal display voltage vary individually and in steps such as over four steps, and three switches are provided for each voltage to change the respective voltages in accordance with the on and off operations thereof, the structure of the device is simple as a whole.

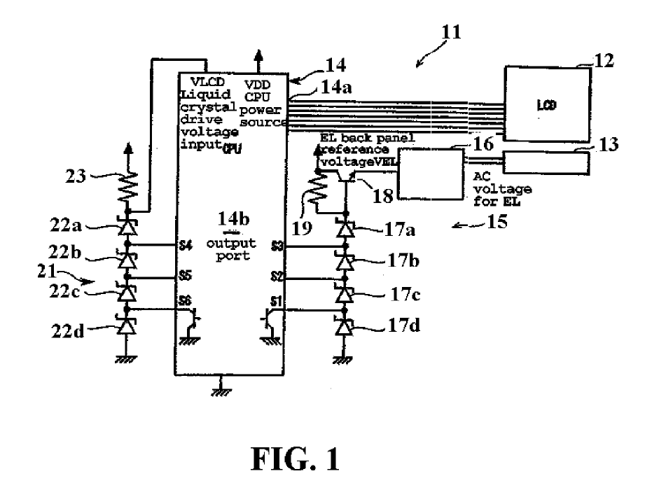

Although the present invention is described above with the example of FIG. 1 is such that the liquid crystal display device in which the luminous intensity of the backlight is adjustable stepwise over multiple steps, the present invention is not limited to this embodiment, as will now become apparent.

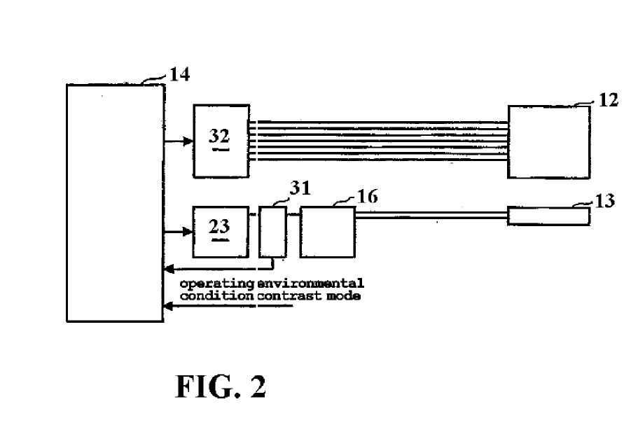

FIG. 2 illustrates a second embodiment of the present invention that is applied to a liquid crystal display device in which the luminous intensity of the backlight is adjustable steplessly. That is the backlight is varied continuously either linearly or along a curve. Additionally, in this embodiment, the components that are the same in operation as those in the first embodiment are assigned the same reference numerals and will be described again only insofar as it is necessary for those skilled in the art to understand and practice this embodiment.

In this embodiment, the luminous intensity of the backlight 13 can be varied steplessly by, for example, a luminous intensity adjustment knob like a rheostat (not shown). The backlight 13 has a power source circuit 23 that can output a linear reference voltage in response to an external signal input. Also, the power source circuit 23 is connected to the backlight 13 through an inverter circuit 16.

A voltage sensor 31 that detects the reference voltage outputted by the power source circuit 23 is interposed between the power source circuit 23 and the inverter circuit 16. The reference voltage detected by the voltage sensor 31 is inputted to the control unit 14.

In addition, a display power source circuit 32 that outputs a stepless drive voltage similar to that of the power source circuit 23 is disposed on the side of the liquid crystal display 12. The operation thereof is controlled by the control unit 14. The control unit 14 computes a display drive voltage using the backlight reference voltage detected by the voltage sensor 31 with, for example, a certain calculation, a mapping or the like, and an operating environmental condition such as surrounding brightness or the like or a contrast mode that is a selected user's preference. Further, the control unit 14 outputs the computed backlight reference voltage to the display power source circuit 32 as a voltage indicating signal.

Therefore, the display 12 can display an image with a contrast that is the most suitable for the luminous intensity of the backlight on all such occasions.

As thus practiced, according to the this embodiment, the user of the present device can adjust the luminous intensity of the backlight steplessly in accordance with operating situations of the device or preference. Also, because the contrast continuously varies along the luminous intensity of the backlight, the visibility of the display can be kept in the good condition every luminous intensity of the backlight.

Additionally, although in this embodiment, the voltage sensor 31 is disposed for the purpose of explanation, voltage information can be directly transmitted to the control unit 14 from the power source circuit 23. Also, the surrounding environmental conditions and the contrast modes can be inputted to the power source circuit 23 so that the luminous intensity can be varied in response to an adjustment amount of a knob.

Thus from the foregoing, it should be apparent to those skilled in the art the present invention can be effectively applied to a liquid crystal display device for a variety of applications in which the luminous intensity of the display can be adjusted either at the operators desire or automatically. Of course those skilled in the art will readily understand that the described embodiments are only exemplary of forms that the invention may take and that various changes and modifications may be made without departing from the spirit and scope of the invention, as defined by the appended claims.

1. A liquid crystal display arrangement comprising a liquid crystal display with a backlight, a backlight power source circuit for supplying a variable drive voltage to said backlight so that a contrast of said liquid crystal display is adjustable, a liquid crystal display power source for supplying a variable drive voltage from said backlight power source circuit to said liquid crystal display for adjusting the contrast of said liquid crystal, and a control means variably controlling said liquid crystal display power source and the luminous intensity of said backlight to maintain the desired visibility.

2. The liquid crystal display device set forth in claim 1, wherein the drive voltage supplied to the backlight is varied in a direction opposite to that of the contrast of the liquid crystal display.

3. The liquid crystal display device set forth in claim 2 wherein the drive voltage supplied to the backlight and the contrast of the liquid crystal display is varied automatically in response to a sensed external condition.

4. The liquid crystal display device set forth in claim 3 wherein the drive voltage supplied to the backlight and the contrast of the liquid crystal display is varied stepwise over the plural steps thereof.

5. The liquid crystal display device set forth in claim 3 wherein the drive voltage supplied to the backlight and the contrast of the liquid crystal display is varied steplessly.

6. The liquid crystal display device set forth in claim 2 wherein the drive voltage supplied to the backlight and the contrast of the liquid crystal display is varied in response to an operator's input.

7. The liquid crystal display device set forth in claim 6 wherein the drive voltage supplied to the backlight and the contrast of the liquid crystal display is varied stepwise over the plural steps thereof.

8. The liquid crystal display device set forth in claim 6 wherein the drive voltage supplied to the backlight and the contrast of the liquid crystal display is varied steplessly.
